(19) United States
(12) Patent Application Publication
(10) Pub. No.: US 2015/0183206 A1
(43) Pub. Date: Jul. 2, 2015

(54) METHOD FOR ADJUSTING THE PRINT REPEAT LENGTH OF A PRINT IMAGE IN A MULTICOLOR ROTARY PRINTING MACHINE

(71) Applicant: Windmoeller & Hoelscher KG, Lengerich (DE)

(72) Inventors: Mario Frankenberg, Osnabrueck (DE); Rainer Ehrenberg, Hasbergen (DE); Frank Westhof, Recke (DE); Uwe Hoewelmeyer, Ibbenbueren (DE)

(21) Appl. No.: 14/415,000

(22) PCT Filed: Jul. 31, 2013
(86) PCT No.: PCT/EP2013/066127

§ 371 Date: Jan. 15, 2015

Related U.S. Application Data
(60) Provisional application No. 61/677,608, filed on Jul. 31, 2012.

(51) Int. Cl. B41F 5/24

(52) U.S. Cl. CPC B41F 5/24

(57) ABSTRACT

A method for adjusting the print repeat length of a print image in a multicolor rotary printing machine, particularly a flexographic printing press, having a first plate cylinder and at least one further plate cylinder,
wherein the plate cylinder is on a shared, or multiple, central impression cylinder which conveys the print substrate, and
wherein the peripheral, velocity of the first plate cylinder is adjusted relative to the peripheral velocity of the central impression cylinder,
characterized in that
the peripheral, velocity of the first plate cylinder is modified during the ongoing printing operation, relative to the peripheral velocity of the central impression cylinder.

The invention relates to a method for adjusting the print repeat length of a print image in a multicolor rotary printing machine, according to the preamble of claim 1.

In a multicolor rotary printing machine, the multicolor print image is transmitted to the print substrate by multiple printing cylinders—the so-called plate cylinders—each transferring a color to the print substrate one after the other, wherein the regions of the plate cylinder which carry the color ink entirely or partially transfer this color ink to the print substrate. Multiple colors which overlap then form the print image.

The print substrate in this case is guided via one or multiple central impression cylinders. If there is only one central impression cylinder, the plate cylinder is positioned against this central impression cylinder, such that the color inks are transferred as completely as possible.

If there are multiple central impression cylinders, a single plate cylinder is frequently functionally assigned to each central impression cylinder such that the peripheral velocity can be adjusted very precisely. However, two or even more plate cylinders can also be functionally assigned to each central impression cylinder.

In general, the peripheral velocities of all plate cylinders should be identical, and also match the peripheral velocity or velocities of the central impression cylinder or central impression cylinders. In the printing machines used today, each individual cylinder is equipped with its own, position-controlled drive such that the peripheral velocity can be very precisely adjusted. High print quality is achieved when all rolls participating in the printing process have the same peripheral velocities.

For a given circumference of the plate cylinders, which can also be identical for each of the same, the so-called print repeat length is defined by one rolling of the plate cylinder on the print substrate. If the print repeat length is changed, the plate cylinder or parts thereof—particularly the so-called print sleeve—must normally be exchanged for a larger or smaller circumference.

However, the document U.S. Pat. No. 7,584,699 B2 suggests modifying the peripheral velocity of the plate cylinder relative to the peripheral velocity of the central impression cylinder or the central impression cylinders, in order to thereby make it possible to vary the print repeat length. The assumption is made that a modification of less than 1% of the original print repeat length has no effect, or at least no noticeable effect, on the print quality. The background to this suggestion is that the printed and re-rolled print substrate, consisting of plastic, changes its length over time. As such, relaxation effects can arise which shrink the film or stretch the same. In order to then make it possible to observe a print image of the desired length, the shrinkage or elongation is anticipated, and an accordingly elongated or shortened print image is produced during the print process, and the plate cylinder is not exchanged for another.

Even though modern printing machines have a position-controlled drive for each cylinder, it is only possible to carry out such a modified adjustment of the peripheral velocity when the printing machine is halted. This consumes a great deal of time, and is therefore costly.

The problem addressed by the present invention is therefore that of suggesting a method which saves more time.

This problem is addressed by the features of claim 1.

Proceeding from a method according to the preamble of claim 1, according to the invention the peripheral velocity of the first plate cylinder is modified during the ongoing printing operation, relative to the peripheral velocity of the central impression cylinder. For this purpose, the control and/or regulation device, which advantageously runs as a program on a control and/or regulation computer, can be informed of the value of the desired peripheral velocity of the plate cylinder or the desired deviation from the peripheral velocity of the central impression cylinder. This can be performed manually or according to a table which contains such values in dependence on the time and/or the length of the material web which has already been printed. However, it can also be contemplated that a mathematical function or an empirically determined dependency is used as is suggested in document U.S. Pat. No. 7,584,699 B2 named above. If the peripheral velocity of the plate cylinder is reduced relative to the peripheral velocity of the central impression cylinder, an elongated print image results.

However, if the peripheral velocity of the plate cylinder is increased relative to the peripheral velocity of the central impression cylinder, a shortened print image is observed.

This method is particularly advantageous for use in a flexographic printing machine. Flexography is a letterpress process—meaning that the raised regions of the plate cylinder or printing plate are the regions which effect the printing. The printing plates in this case consist of flexible materials such as polymers, such that the printing plates can properly cope with the bending forces produced by the slightly different peripheral velocities of the plate cylinder and central impression cylinder.

A difficulty arises at this point if multiple, single-color partial images are supposed to be printed to make a multicolor print, matching the impression made by the first plate cylinder with its modified velocity. In a further embodiment, therefore, the peripheral velocity of at least one further plate cylinder is also modified at the same time as the modification of the peripheral velocity of the first plate cylinder. The peripheral velocities of these plate cylinders in this case should be identical, at least following several rotations.

In a further embodiment of the invention, the peripheral velocity of not only one additional plate cylinder, but rather of all further plate cylinders is modified at the same time as the first plate cylinder.

In the methods according to the invention described above, the term ‘peripheral velocities’ means the target peripheral velocities. The target peripheral velocities in this case depend on the peripheral velocity of the central impression cylinder or central impression cylinders, and are only slightly modified relative to the peripheral velocities thereof. The actual peripheral velocities of the plate cylinders in this case can, however, deviate from the target plate cylinder, as described below, because additional adjustment parameters influence the actual peripheral velocity.

When the target peripheral velocities of different plate cylinders are modified at the same time, the problem arises that the longitudinal register is then generally no longer adjusted to match. A well-adjusted longitudinal register ensures that the individual colors of a print image are printed on top of each other, and together accordingly form the desired print image.

When the target peripheral velocities of at least two of the plate cylinders are modified at the same time, at least a part of the print image printed by the first plate cylinder has at [sic] the original peripheral velocity—that is, at the original print repeat length. At this point, if a further plate cylinder which is already operated at the modified speed prints over this print image, an error in the longitudinal register necessarily results. This produces paper waste, which should be prevented.

One suitable measure for preventing the creation of waste paper is that of controlling the additional plate cylinders as follows: the longitudinal register is controlled at the same time as the new target peripheral velocity is specified, in such a manner that the longitudinal register is preserved, or at least only briefly disturbed, despite the modified peripheral velocity.

It is possible to completely avoid paper waste if the longitudinal register is controlled in such a manner that it likewise performs a modification of the target peripheral velocity, wherein the target peripheral velocity specified by the longitudinal register has precisely the same magnitude as the modification of the target peripheral velocity used to generate a different print repeat length, but works against this modification. in sum, a peripheral velocity which corresponds to the original peripheral velocity is preserved. The control procedure for the longitudinal register is maintained up to the point on the print substrate at which the print image with the modified print repeat length starts and reaches the roll gap between the additional plate cylinder and the central impression cylinder. This point in time is simple to calculate, and only depends on the velocity of the central impression cylinder (v_{impression cylinder})—via Δt=ΔL/v_{impression cylinder}—wherein ΔL is the roll gap of the two plate cylinders with the central impression cylinder, measured along the surface of the central impression cylinder.

In one preferred embodiment of the invention, a control and/or regulating program is used which comprises multiple procedures. In the scope of this application, ‘procedures’ indicates individual program components which fulfil a certain function. However, such procedures can also be termed ‘functions’. Also, other terms may also be used in the field of IT.

Such a procedure can serve the purpose of controlling the target peripheral velocities, by way of example, and can contain the target print repeat length as an input parameter, by way of example. In this case, a result would be a value for the target peripheral velocity which is then relayed to the program component which is responsible for the position regulation of a printing roll.

A further procedure which can be contemplated for the adjusting of the longitudinal register of plate cylinders can likewise calculate the value of the target peripheral velocity, and provision this value with the opposite sign, and also calculate the duration of the length of the longitudinal register adjustment according to the position of the plate cylinder being controlled. These two values as well are transferred to the program component which is responsible for the position regulation.

At this point, the two values for the differences of the target peripheral velocity and the current peripheral velocity of the central impression cylinder are added to the current velocity, according to the amount of time t which has passed, in the program component for the position regulation of a certain plate cylinder. If the time Δt has run out, the difference between the original peripheral velocity and the target velocity used to modify the longitudinal register equals zero, such that the affected plate cylinder at this point is running in proper register with the new target peripheral velocity which is necessary for modifying the print repeat length without the print image ever running out of the register.

The invention also includes a control and/or regulating device in which the plate cylinders described above are implemented, as well as a printing machine which includes a control and/or regulating device as named. This printing machine is also equipped with one or multiple central impression cylinders which transport a print substrate web, wherein one or multiple plate cylinders can be brought into contact with each of the same. In a particularly advantageous embodiment, the printing machine is a central impression cylinder flexographic printing press.

Further embodiments are found in the additional claims and the drawings, wherein:

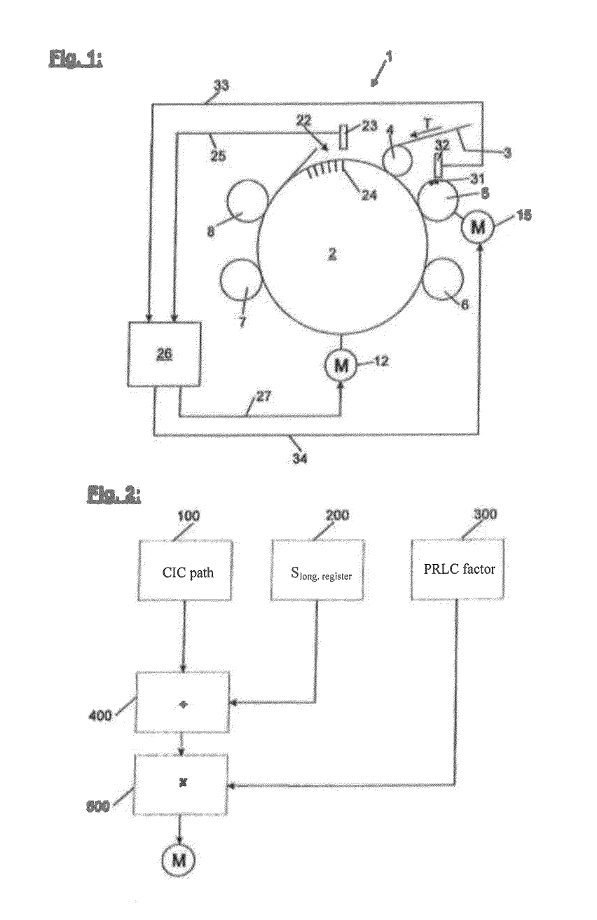

FIG. 1 shows a schematic view of a flexographic printing press with a control device,

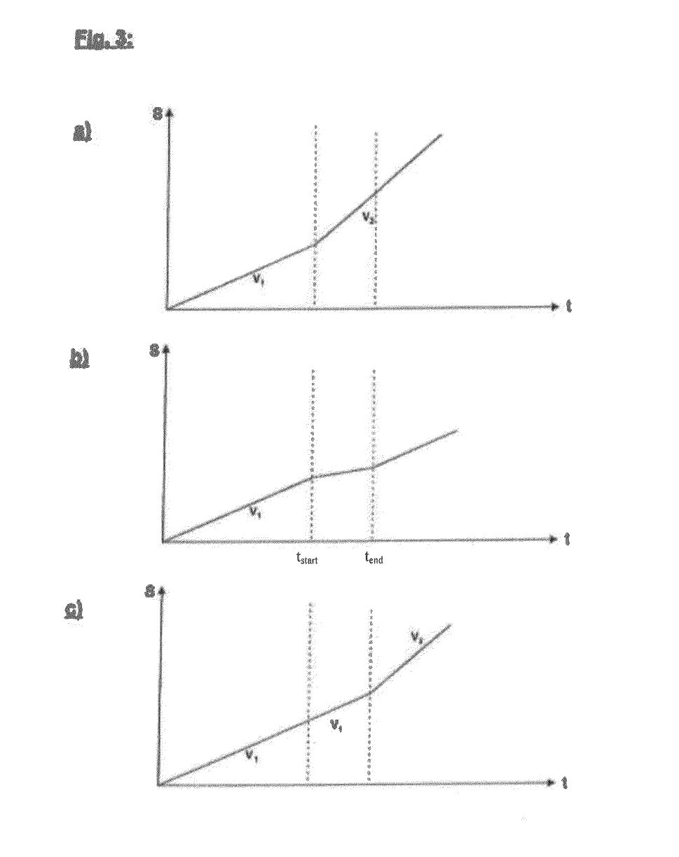

FIG. 2 shows the process of a method according to the invention for adjusting the print repeat length, and

FIG. 3 shows various velocity curves of a plate cylinder when the velocity thereof is modified.

FIG. 1 shows a schematic illustration of a flexographic printing press 1, which has a central impression cylinder 2. A web of print substrate 3 is fed in the direction of the arrow T, and is laid onto the central impression cylinder 2 by means of a pressure roller 4. Multiple—and particularly 4 in the shown embodiment—plate cylinders 5, 6, 7, 8 are distributed about the periphery of the central impression cylinder 2, each printing one color. However, only the first has not been shown [sic], but devices for the purpose of conveying ink are part of each printing machine, wherein the letterpress printing regions of the plate cylinders are supplied with color ink via the same. In flexographic printing presses, such a device generally comprises an anilox roll for the purpose of inking the print regions, and a doctor blade which works together with the anilox roll.

In addition, FIG. 1 shows components of the flexographic printing press 1 which serve the purpose of driving cylinders. As such, the central impression cylinder 2 is driven by its own drive 12. The letter M in the illustration stands for ‘motor’. Even if the motor is operated at a prespecified power, which should lead to a constant rotation speed, fluttering can occur. In order to make it possible to determine the actual rotation speed, a rotation speed detection device is included, indicated overall with the reference number 22. The rotation speed detection device has a sensor 23 by means of which it is possible to detect the markings 24 which are arranged on the central impression cylinder 2. The detected markings are relayed to the analysis and control device 26 via a data line 25, which analyzes the markings therefrom per unit of time, and from this determines the actual angular and peripheral velocity. If a deviation from the desired angular velocity is found, the motor can be accordingly controlled such that target and current velocities equalize. A control path is therefore available for this case. A control line leads from the analysis and control device 26 to the motor 12.

In flexographic printing presses in the prior art, the individual plate cylinders should have the same peripheral velocities at every point in time as the central impression cylinder 2. For this purpose, the same control path is used as for the central impression cylinder 2. Such a control path is only illustrated for the plate cylinder 5, but is likewise present for the other plate cylinders. It is initially important that the rotation of each plate cylinder is started by its own drive. The drive in the case of plate cylinder 5 has the reference number 15. The control device in this case also includes the markings 31, the sensor 32, and the control line 33, which relays the number of the markings measured by the sensor to the analysis and control device 26. The latter evaluates the measured value with respect to a unit of time, and in turn determines the current peripheral velocity of the plate cylinder 5. The current peripheral velocity is also compared to a target velocity, wherein in this case the target velocity is not a prespecified velocity, but rather the current velocity of the central impression cylinder. As a result of this approach, the method ensures that the peripheral velocities of the central impression cylinder and the plate cylinders are always the same.

At this point, if the peripheral velocities of the plate cylinders 5, 6, 7, 8 are intended to be modified relative to the central impression cylinder, the corresponding differences are added to the target velocities of the plate cylinders. These differences can result in a higher peripheral velocity, and result in a slightly shortened print repeat length. In contrast, a reduced peripheral velocity leads to an elongated print image.

One embodiment of a circuit or a program procedure is shown in FIG. 2. The individual boxes in this figure are accordingly intended as circuit components or parts of a program—for example as procedures. The drive of a plate cylinder is controlled in this was. As described above, the basis for the control operation of the drive is the current peripheral velocity of the central impression cylinder. This is illustrated in box 100, wherein the path of the central impression cylinder (CIC path) traveled per unit of time is taken as the basis. For a printing wherein not all plate cylinders are yet in the register, the missing path difference is added in order to achieve a satisfactory register. The path difference in the register is generally detected by register sensors which scan the printing marks of the individual colors. The missing path difference continues to be added until the register matches (S_{long, register}). This is indicated by the reference number 200. The actual addition is performed in the component and/or procedure 400.

At this point, if a velocity difference between the central impression cylinder and the affected plate cylinder is added, the path sum is multiplied by a factor which is greater or smaller than 1. This occurs in the multiplier, which is shown as box 500. The result is a path specification which the periphery of the plate cylinder has travelled during one unit of time. The motor M is controlled according to this specification.

An approach is illustrated in FIG. 3, by means of which it is possible to add the velocity difference for all plate cylinders at the same time, and to prevent a longitudinal register deviation. For this purpose, the velocity difference Δv from the new velocity v₂ is determined proceeding from the original peripheral velocity v₁. A resulting velocity curve is illustrated in FIG. 3a), wherein the peripheral velocity of the affected plate cylinder was simply modified from v₁ to v₂ at a time point t_{Start}.

Along with the time point at which the new velocity v2 is added, this difference path is incorporated as a longitudinal register path to be corrected. This longitudinal register path continues to be incorporated from time point t1 until the difference path traveled per unit of time is determined from Δv. This difference path is taken into account as the longitudinal register path to be corrected, along with the time point of the adding of the new velocity. This longitudinal register path is incorporated at this point, starting at v₁, for the time in which the print substrate needs to travel at the given peripheral velocity from the first plate cylinder (see reference number 5 in FIG. 1) to the plate cylinder being adjusted. The duration needed for this is found for the given peripheral velocity of the central impression cylinder, which is equal to v₁, from the radius of the central impression cylinder, which is a constant. The longitudinal register path up to time point t_{End} is incorporated accordingly. While the time point t_{Start} is the same for all plate cylinders, the time point t_{End} depends on the spatial position of the affected plate cylinder relative to the central impression cylinder. Because in this approach the adjustment of the longitudinal register—not measured values—is used which are detected by sensors, this can be considered a correction of a virtual longitudinal register error. Such a correction of the longitudinal register error is shown in FIG. 3b).

FIG. 3c) shows the velocity curve resulting from the above for the plate cylinder in question. The velocity difference Δv and the velocity modification resulting from the longitudinal register correction exactly cancel each other out, such that the peripheral velocity v₁ is maintained between the time points t_{Start} and t_{End}.

In this manner, a print image which was already in the process of being printed at the original speed, is also completely finished at this speed. This print therefore does not result in any waste paper.

The described approach is advantageous because in this case only little needs to be modified in printing machines of the prior art, in terms of control devices, in order to make it possible to carry out the method according to the invention. The so-called print repeat length correction—that is, the velocity v2—can be easily added. To prevent paper waste, the function for the longitudinal register correction, which is present in the prior art as well, can be modified by the addition of the calculated (rather than measured) values at this point.

In addition to the method according to the invention, a printing machine is also the subject matter of the invention, wherein an analysis and control device 26 is equipped with the described functions.

In the description above, as well as the drawings and the claims, various embodiments and features of a method according to the invention and of a device according to the invention have been described. All of these features can be freely combined with each other to the extent this is technically feasible, without departing from the scope of the present invention.

1. A method for adjusting the print repeat length of a print image in a multicolor rotary printing machine, particularly in a flexographic printing press, having a first plate cylinder and at least one further plate cylinder,
wherein the plate cylinder is on [sic] a shared, or multiple, central impression cylinder which conveys the print substrate, and
wherein the peripheral velocity of the first plate cylinder is adjusted relative to the per velocity of the central impression cylinder,
characterized in that
the peripheral velocity of the first plate cylinder is modified during the ongoing printing operation, relative to the peripheral velocity of the central impression cylinder.

2. A method according to claim 1,
characterized in that
the peripheral velocity of at least one further plate cylinder is also modified at the same time as the modification of the peripheral velocity of the first plate cylinder.

3. A method according to claim 2,
characterized in that
the peripheral velocity of all other plate cylinders is also modified at the same time as the modification of the peripheral velocity of the first plate cylinder.

4. A method according to claim 2,
characterized in that
the first plate cylinder and the at least one further plate cylinder, or all further plate cylinders, have the same peripheral velocities.

5. A method according to claim 1,
characterized in that
the longitudinal register is also adjusted for each plate cylinder for which the peripheral velocity is modified.

6. A method according to claim 5,
characterized in that
for the affected plate cylinders, the modification of the peripheral velocity and the adjustment of the longitudinal register occur at the same time.

7. A method according to claim 5,
characterized in that
a control and/or regulating program having at least one procedure for the purpose of controlling the peripheral velocity and having at least one procedure for the purpose of controlling the longitudinal register is used, wherein the procedure used for the purpose of controlling the longitudinal register is called at the same time as the procedure for the purpose of controlling the peripheral velocity is called, the same based on the modified value of the peripheral velocity as the new control value.

8. A method according to claim 5,
characterized in that
the modification of the peripheral velocity which is necessary for adjusting the longitudinal register has the same magnitude, but the opposite sign with respect to the desired modified peripheral velocity of the plate cylinder.
